(19) United States
(12) Patent Application Publication
(10) Pub. No.: US 2011/0259931 A1
(43) Pub. Date: Oct. 27, 2011

(54) Auxiliary rack for an ATV

(76) Inventor: Leroy Rellergert, Perryville, MO (US)

(21) Appl. No.: 12/799,426

(22) Filed: Apr. 23, 2010

(51) Int. Cl. B60R 9/00

(52) U.S. Cl. 224/401

(57) ABSTRACT

An auxiliary rack for an ATV is disclosed which comprises a pair of longitudinal bar members, a pair of cross members connected to the longitudinal bar members, a bottom panel member, a first foldable side hingedly connected to the bottom panel member, a second foldable side hingedly connected to the bottom panel member, a first detachable end panel, a second detachable end panel, and a pair of clamp members connected to the pair of longitudinal bar members.

### BACKGROUND

This disclosure relates to a carrier storage rack for an all terrain vehicle (ATV), and more particularly to a universal auxiliary rack for an ATV.

ATVs are used for transportation of an individual for both on and off road activities. ATVs are also used to transport various items such as animals, tents, guns, feed, and equipment. Typically an ATV is equipped with a rack that is mounted on the front and/or rear of the vehicle. The rack is integral with the vehicle and may consist of tubular steel members or plastic members. The members present a horizontal surface upon which items may be attached during transportation. For example, cords may be attached to the tubular members to hold the equipment in place during transit. Some manufacturers of ATVs have designed specialty or auxiliary racks for use with their rack. Some of the specialty racks are used for carrying a specific item and if a different item needs to be transported then another specialty rack needs to be purchased and installed. Further, some of the specialty racks require the removal of the original rack.

As can be appreciated, the original rack installed on the front and/or rear of the ATV is a different size, shape, and construction dependent on the ATV manufacturer. Since there is no standard size and shape to the rack it has been difficult to provide an auxiliary rack that may be used on any ATV.

The present construction is designed to obviate and overcome many of the disadvantages and shortcomings associated with prior auxiliary racks for ATVs. In particular, there is a need for a universal auxiliary rack for an ATV. The present disclosure provides an auxiliary rack for an ATV that can be mounted to any rack of any ATV. The present disclosure also provides an auxiliary rack for an ATV that has a mounting construction that is versatile for adapting to any arrangement of a rack associated with an ATV.

### SUMMARY

In one form of the present disclosure, an auxiliary rack for an ATV comprises a pair of longitudinal bar members, a pair of cross members connected to the longitudinal bar members, a bottom panel member, a first foldable side hingedly connected to the bottom panel member, a second foldable side hingedly connected to the bottom panel member, a first detachable end panel, a second detachable end panel, and a pair of clamp members connected to the pair of longitudinal bar members.

In another form of the present disclosure, an auxiliary rack for an ATV comprises a pair of longitudinal bar members, a pair of cross members connected to the longitudinal bar members, a bottom panel member, a first foldable side hingedly connected to the bottom panel member, a second foldable side hingedly connected to the bottom panel member, a first detachable end panel connected between the first and the second foldable sides, a second detachable end panel connected between the first and the second foldable sides, a first pair of clamp members connected to one of the pair of longitudinal bar members, and a second pair of clamp members connected to the other one of the pair of longitudinal bar members.

In yet another form of the present disclosure, an auxiliary rack for an ATV comprises a pair of longitudinal bar members, a pair of cross members connected to the longitudinal bar members, a bottom panel member, a first foldable side hingedly connected to the bottom panel member, a second foldable side hingedly connected to the bottom panel member, a first foldable end panel hingedly connected to the bottom panel member, a second foldable end panel hingedly connected to the bottom panel member, and a pair of clamp members connected to the pair of longitudinal bar members.

In light of the foregoing comments, it will be recognized that the present disclosure provides an auxiliary rack for an ATV which is of simple construction and design and which can be easily employed with highly reliable results.

The present disclosure provides an auxiliary rack for an ATV that is versatile and adaptable to fit on any existing rack associated with an ATV.

The present disclosure provides an auxiliary rack for an ATV that is capable of being manufactured using commonly available components that are relatively inexpensive.

The present disclosure provides an auxiliary rack for an ATV that does not require the ATV to be modified to accept the auxiliary rack.

The present disclosure provides an auxiliary rack for an ATV that can easily be attached or removed from an existing rack associated with the ATV

The present disclosure provides an auxiliary rack for an ATV that is strong, reliable, and durable for carrying and transporting various items.

The present disclosure provides an auxiliary rack for an ATV that is collapsible for storage or for providing a flat surface for carrying various items.

The present disclosure will become apparent after considering the following detailed specification in conjunction with the accompanying drawings, wherein:

### BRIEF DESCRIPTION OF THE DRAWINGS

FIG. 1 is a perspective view of a preferred embodiment of an auxiliary rack for an ATV constructed according to the present disclosure;

FIG. 2 is a perspective view of the auxiliary rack shown in FIG. 1 in a folded state;

FIG. 3 is a perspective view of a hinge;

FIG. 4 is an enlarged partial perspective view of a pair of attachment members being securing an end panel to a side panel; and

FIG. 5 is a cross sectional view of an attachment clamp for clamping the auxiliary rack to an existing rack of an ATV.

### DETAILED DESCRIPTION OF EMBODIMENTS

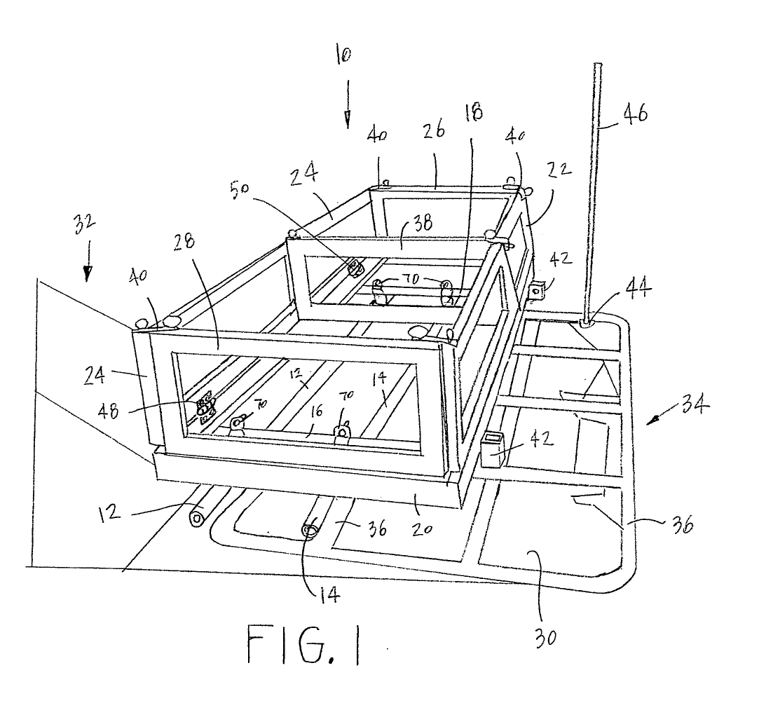

Referring now to the drawings, wherein like numbers refer to like items, number 10 identifies a preferred embodiment of an auxiliary rack for an ATV constructed according to the present disclosure. With reference now to FIG. 1, the auxiliary rack 10 is shown comprising a pair of longitudinal bar members 12 and 14, a pair of cross members 16 and 18 connected to the longitudinal bar members 12 and 14, and a bottom panel member 20. The bar members 12 and 14 and the cross members 16 and 18 may be tubular steel rods or other rod material such as plastic, metal, or carbon fiber. It is also contemplated that the cross members 16 and 18 may be parallel to the bar members 12 and 14. A first foldable side 22 is hingedly connected to the bottom panel member 20. A second foldable side 24 is also connected to the bottom panel member 20 by use of a pair of hinges 48 and 50. The bottom panel member 20 may take on various sizes and shapes and may be constructed from various materials such as tubular steel, metal, plastic, carbon fiber material, and wood. Although not shown, the bottom panel member 20 may have a floor comprised of flattened expanded metal or other suitable material such as a piece of plastic, metal, carbon fiber, or wood. It is also contemplated that the floor may have openings, such as provided by flattened expanded metal, or the floor may be solid without any openings. The first side 22 and the second side 24 may also be of various sizes and shapes and may be constructed of various materials such as the bottom panel member 20. The sides 22 and 24 may also be fitted or covered with flattened expanded metal or other suitable material. As can be appreciated the sides 22 and 24 are sized the same as the bottom panel 20.

The auxiliary rack 10 also comprises a first detachable end panel 26 and a second detachable end panel 28. The end panels 26 and 28 are adapted to be attached to the sides 22 and 24 by use of attachment members 40. Although the end panels 26 and 28 are shown attached at the ends of the sides 22 and 24 it is possible that the end panels 26 and 28 may be attached to the sides 22 and 24 at any position along the lengths of the sides 22 and 24. The end panels 26 and 28 may be constructed in the same manner and material as the bottom panel 20 or the sides 22 and 24. Also, the end panels 26 and 28 may be covered with flattened expanded metal or the panels 26 and 28 may be fully enclosed.

The auxiliary rack 10 is shown being attached to a rear end 30 of an ATV 32. The rear end 30 has an existing rack 34 constructed of various tubular members 36. The ATV 32 also has a front end (not shown) that has another existing rack. The auxiliary rack 10 may also be attached to the existing rack associated with the front end of the ATV 32. The manner of attaching the auxiliary rack 10 will be explained in further detail herein.

The auxiliary rack 10 may also comprise a detachable center panel member 38 that may be attached to the side panels 22 and 24. The center panel member 38 may be constructed in the same manner and material as the end panels 26 and 28. Also, the center panel member 38 may be covered with flattened expanded metal or the panel 38 may be fully enclosed. Although the center panel 38 is shown being centrally positioned it is also possible that the center panel 38 may be positioned any where along the lengths of the side panels 22 and 24. The center panel 38 is employed to hold two similar items, such as barrels, in place during transportation of the items. For example, two containers of feed may be placed in the rack 10 and the center panel 38 helps to keep the containers from falling or moving during transit. The center panel member 38 may be attached to the side panels 22 and 24 by use of a pair of attachment member 40 at the top and a pair of attachment members 40 at the bottom. The attachment members 40 will be described in detail further herein. A cord attachment member 42 is positioned at each end of the pair of cross members 16 and 18. The cord attachment members 42 are adapted to have a cord attach thereto to hold items in place that are stored within the rack 10. A flag attachment member 44, as shown connected to the existing rack 34, may be welded or connected to the cord attachment member 42 or the bottom panel 20. A flag 46 may be inserted into the flag attachment member 44.

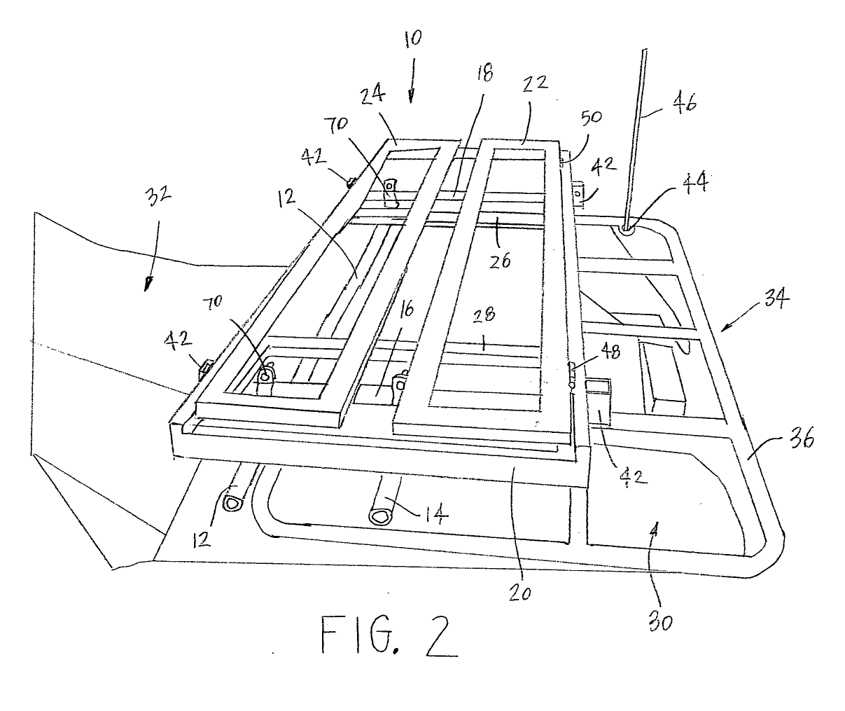

With reference now to FIG. 2, the auxiliary rack 10 is shown in a folded position. The rack 10 may need to be folded to carry flat items that are larger than the rack 10. The rack 10 is folded by removing the end panels 26 and 28 and the center panel 38. Although not shown, the end panels 26 and 28 may be attached to the sides of the panels 22 and 24 by use of the attachment members 40 or stored elsewhere. The side panels 22 and 24 fold flat by use of a pair of hinges 48 and 50 associated with each of the side panels 22 and 24.

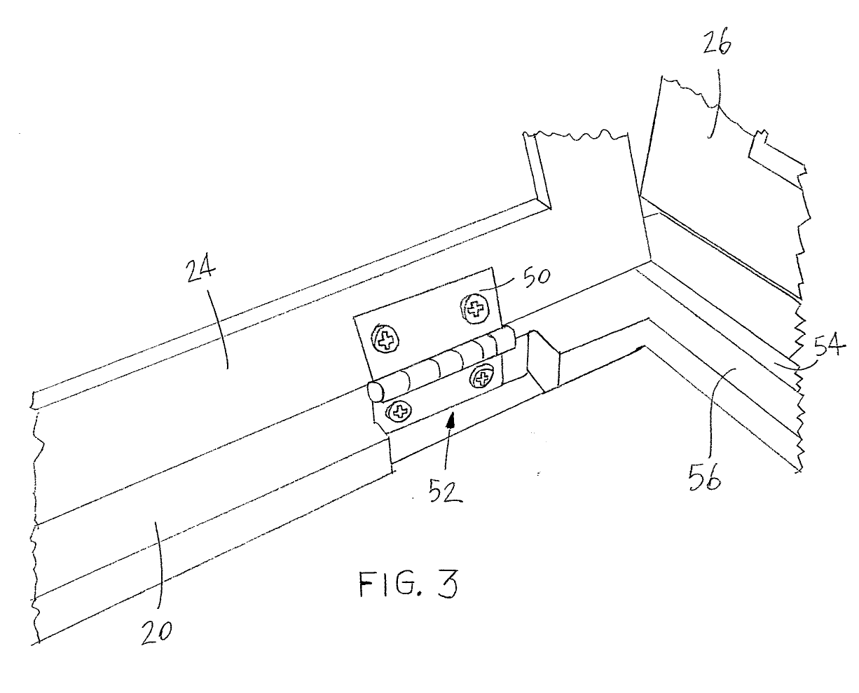

FIG. 3 depicts the manner in which one of the hinges 50 is set into the bottom panel 20 to allow the side panel 24 to fold flat. In particular, the bottom panel 20 has a portion 52 cut out of the panel 20 to allow the hinge 46 to be connected to the bottom panel 20. The panel 20 has a cut out portion 52 at the other areas in which the other hinges 48 and 50 are positioned around the panel 20. Further, although the end panels 26 and 28 have been described as being attached to the side panels 22 and 24 it is also possible that the end panels 26 and 28 may be hinged to the bottom panel 20 by the use of a pair of hinges 48 and 50. In this manner the end panels 26 and 28 are foldable and can be collapsed in the same manner as the side panels 22 and 24. In particular, the end panel 26 is shown being elevated above the side panel 24 by use of a strip of material 54. In this manner the end panel 26 may be folded over the top of the side panels 22 and 24 when the side panels 22 and 24 are folded. It is also possible that the strip of material 54 may instead be on the side associated with the side panels 22 and 24 so that the side panels 22 and 24 may fold over the top of the end panels 26 and 28. The bottom panel 20 also has a ledge or lip portion 56 which allows a piece of expanded metal or other material to be positioned or connected to the bottom panel 20.

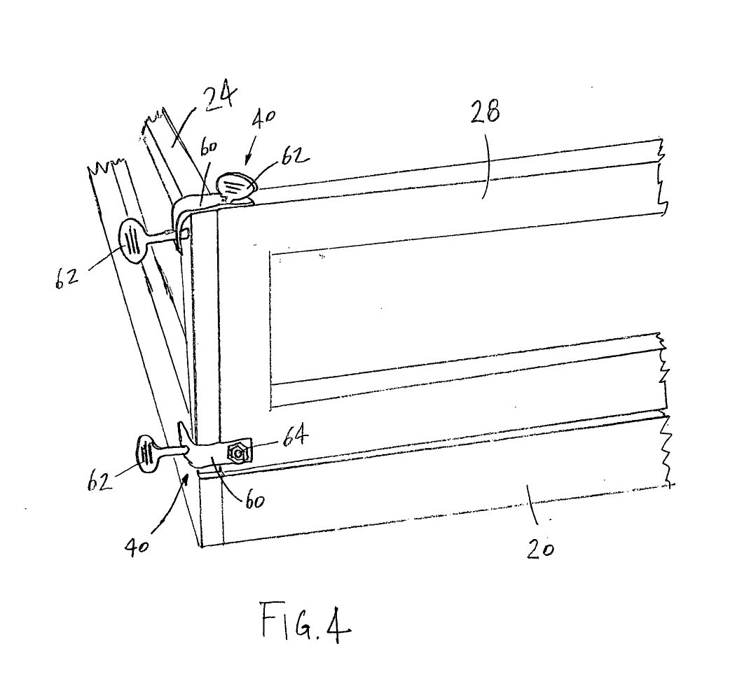

Referring now to FIG. 4, a pair of attachment members 40 is shown securing the end panel 28 to the side panel 24. The attachment member 40 comprises an L shaped member 60 in which two opening, which are not visible in this particular view, have either a thumb screw 62 or a nut and bolt combination 64 inserted therein. Although not shown in any detail the end panel 28 and the side panel 24 may have apertures or openings provided therein for receiving the thumb screws 62 or the nut and bolt combinations 64. It is also possible that the thumb screw 62 may be a latch type device that is spring loaded so that pulling on the latch device will remove the latch from the opening in the end panel 28 or the side panel 24. Other attachment mechanisms are possible.

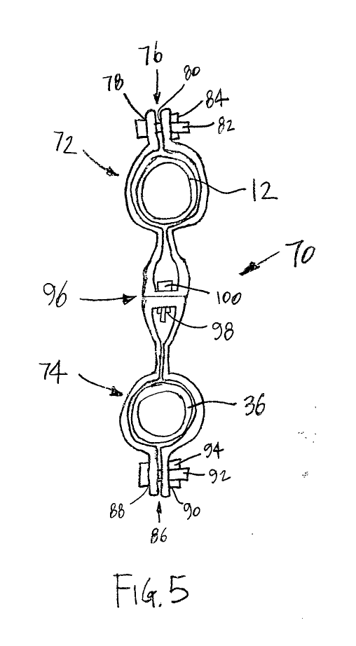

FIG. 5 illustrates an attachment clamp or clamp member 70 for clamping or attaching the longitudinal bar member 12 of the auxiliary rack 10 to one of the tubular members 36 of the existing rack 34 of the ATV 32. The attachment clamp 70 consists of a pair of complementary C shaped bodies 72 and 74 that are adapted to fit around the member 12 and the member 36. The body 72 has an end 76 that has a pair of apertures 78 and 80 through which a bolt 82 is inserted. A nut 84 is inserted on the bolt 82 and tightened to secure the body 72 on the member 12. The body 74 also has an end 86 that has a pair of apertures 88 and 90 through which a bolt 92 is inserted. A nut 94 is inserted on the bolt 92 and tightened to secure the body 74 on the member 36 to secure the rack 10 to the existing rack 34. A center portion 96 connects the two bodies 72 and 74 together by use of a nut 98 and a bolt 100. In this manner the two bodies 72 and 74 may be rotated or swiveled as required. It is also possible that the bodies 72 and 74 are one integral piece or that the bodies 72 and 74 are separate pieces connected together at the center portion 96 such as by welding or by a rivet. As can be appreciated, the rack 10 can be positioned or adjusted along the existing rack 34 by loosening the nuts 84 and 94. The attachment clamp 70 may also be used to connect together the cross members 16 and 18 to the longitudinal bar members 12 and 14. With the use of the attachment clamp 70 the cross members 16 and 18 may be adjusted relative to the bar members 12 and 14. Other connecting or clamping devices are possible and contemplated.

The auxiliary rack 10 operates as follows. The attachment clamps 70 of the auxiliary rack 10 are adjusted to fit over the tubular members 36 of the existing rack 34 of the ATV 32 to be used. The attachment clamps 70 are secured in place by use of the bolts 92 and nuts 94. Once in place the end panels 26 and 28 are positioned where desired and secured to the side panels 22 and 24 by use of the attachment members 40. If required the center panel 38 is positioned where desired and secured to the side panels 22 and 24 by use of the attachment members 40. The auxiliary rack 10 is then loaded with the items that need to be transported. Cords, such as bungee cords, may be used to tie down or hold in place the items stored in the auxiliary rack 10. The cords typically have hooked ends which may be inserted into apertures provided in the cord attachment members 42. As has been previously described, the auxiliary rack 10 may be folded in place to accept flat objects or an auxiliary flat work surface.

From all that has been said, it will be clear that there has thus been shown and described herein an auxiliary rack for an ATV. It will become apparent to those skilled in the art, however, that many changes, modifications, variations, and other uses and applications of the subject auxiliary rack for an ATV are possible and contemplated. All changes, modifications, variations, and other uses and applications which do not depart from the spirit and scope of the subject caster brake assembly are deemed to be covered by the disclosure, which is limited only by the claims which follow.

What is claimed is:

1. An auxiliary rack for an ATV comprising:
a pair of longitudinal bar members;
a pair of cross members connected to the longitudinal bar members;
a bottom panel member;
a first foldable side hingedly connected to the bottom panel member;
a second foldable side hingedly connected to the bottom panel member;
a first detachable end panel;
a second detachable end panel; and
a pair of clamp members connected to the pair of longitudinal bar members.

2. The auxiliary rack for an ATV of claim 1 further comprising a second pair of clamp members connected to the pair of longitudinal bar members, the second pair of clamp members for securing the auxiliary rack to an existing rack of an ATV.

3. The auxiliary rack for an ATV of claim 1 further comprising a detachable center panel for attachment to the first and second side panels.

4. The auxiliary rack for an ATV of claim 1 wherein the first and second end panels may be repositioned along the first and second side panels.

5. The auxiliary rack for an ATV of claim 1 further comprising a pair of hinges for attaching the first foldable side to the bottom panel member.

6. The auxiliary rack for an ATV of claim 1 further comprising a pair of hinges for attaching the second foldable side to the bottom panel member.

7. The auxiliary rack for an ATV of claim 1 further comprising a cord attachment member connected to one of the cross members.

8. The auxiliary rack for an ATV of claim 1 wherein each of the clamp members comprises a pair of C shaped bodies bolted to each other to being able to rotate relative to each body.

9. An auxiliary rack for an ATV comprising:
a pair of longitudinal bar members;
a pair of cross members connected to the longitudinal bar members;
a bottom panel member;
a first foldable side hingedly connected to the bottom panel member;
a second foldable side hingedly connected to the bottom panel member;
a first detachable end panel connected between the first and the second foldable sides;
a second detachable end panel connected between the first and the second foldable sides;
a first pair of clamp members connected to one of the pair of longitudinal bar members; and
a second pair of clamp members connected to the other one of the pair of longitudinal bar members.

10. The auxiliary rack for an ATV of claim 9 further comprising a detachable center panel for attachment to the first and second side panels.

11. The auxiliary rack for an ATV of claim 10 wherein the detachable center panel is attached to the first and second side panels by use of a pair of L shape members and screws.

12. The auxiliary rack for an ATV of claim 9 further comprising a pair hinges for attaching the first foldable side to the bottom panel member.

13. The auxiliary rack for an ATV of claim 9 further comprising a pair hinges for attaching the second foldable side to the bottom panel member.

14. The auxiliary rack for an ATV of claim 9 further comprising a cord attachment member connected to one of the cross members.

15. The auxiliary rack for an ATV of claim 14 further comprising a flag attachment member connected to the cord attachment member.

16. The auxiliary rack for an ATV of claim 9 further comprising a cord attachment member connected to each of the cross members.

17. The auxiliary rack for an ATV of claim 16 further comprising a flag attachment member connected to each of the cord attachment members.

18. An auxiliary rack for an ATV comprising:
a pair of longitudinal bar members;
a pair of cross members connected to the longitudinal bar members;
a bottom panel member;
a first foldable side hingedly connected to the bottom panel member;
a second foldable side hingedly connected to the bottom panel member;
a first foldable end panel hingedly connected to the bottom panel member;
a second foldable end panel hingedly connected to the bottom panel member; and
a pair of clamp members connected to the pair of longitudinal bar members.

19. The auxiliary rack for an ATV of claim 18 further comprising a detachable center panel for attachment to the first and second side panels.

20. The auxiliary rack for an ATV of claim 18 further comprising a cord attachment member connected to each of the cross members.
